(19) United States
(12) Patent Application Publication
(10) Pub. No.: US 2017/0223216 A1
(43) Pub. Date: Aug. 3, 2017

(54) SYSTEM AND METHOD FOR PROXIMITY-BASED DISCOVERY OF MULTIFUNCTION DEVICES

(71) Applicants: Kabushiki Kaisha Toshiba, Minato-ku (JP); Toshiba TEC Kabushiki Kaisha, Shinagawa-ku (JP)

(72) Inventors: William Su, Riverside, CA (US); Jenny Zhang, Irvine, CA (US)

(21) Appl. No.: 15/010,427

(22) Filed: Jan. 29, 2016

(51) Int. Cl. H04N 1/32; H04N 1/00; H04W 76/02; H04W 4/00; H04W 76/06

(52) U.S. Cl. CPC H04N 1/32096; H04W 4/008; H04W 76/06; H04W 76/023; H04N 1/00204; H04W 84/12

(57) ABSTRACT

A document processing system includes an embedded controller that has both a local area network interface for receiving documents over an associated network and a wireless personal area network interface for communicating with mobile computing devices using BLUETOOTH low power communications. The embedded controller transmits broadcasts message to nearby mobile computing devices that send responses to the broadcast messages. Based on the RSSI of a received response, the embedded controller can determines whether a particular mobile computing device is in close proximity, indicating that a user is present at the document processing system. The embedded controller sends identification data associated with the document processing system to the mobile computing device. The user of the mobile computing device selects the document processing system to print a document, and the mobile computing device uses the identification data to route the document to the document processing system over a wireless local area network.

### TECHNICAL FIELD

The subject application teaches embodiments that relate generally to selecting a multifunction printer using proximity-based discovery methods, and specifically to using a mobile computing device to print to a multifunction printer that is in close proximity.

### SUMMARY

In an example embodiment, a document processing system includes an embedded controller and a wireless personal area network interface that is configured to communicate with nearby mobile computing devices. When a mobile computing device is in close proximity to the document processing system, indicating that a user is at the document processing system, the embedded controller is configured to send identifying data via the wireless personal area network to the mobile computing device. The identifying data can be used to determine addressing information for the document processing system such that the mobile computing device can send documents to be printed via a local area network. To discover mobile computing devices, the embedded controller transmits a UUID or universally unique identifier via the wireless person network interface, and receives a response from the mobile computing devices. The RSSI or received signal strength indicator of the response can be used to determine the approximate distance to the mobile computing devices. The BLUETOOTH low energy protocol is an example wireless personal area network protocol that includes a distance approximating feature. Mobile computing devices can include mobile phones, smart phones, pad-based computing devices, laptops, heads up displays or glasses-based computing devices, and smart watches. The embedded controller can include a local area network interface for wired or wireless network communications with a local network. The document processing system typically receives documents that are to be printed via the local network. The document processing system can include associated mobile computing devices configured to send a document to the document processing device using the document processing device's identity that was provided in the identifying data sent to the mobile computing device over the wireless personal area network. The mobile computing device sends the document to the document processing device using the local area network, for example using a wireless local area network interface. In a configuration, the document processing system includes an identifying label. The mobile computing device is configured to capture an image of the label, and use the information from the label to identify the document processing system. The label can include a QR or quick response code, a barcode, the name of the document processing system, the document processing system serial number, IP address or Internet Protocol address, or MAC address or Media Access Control address, or a URL or uniform resource locator for obtaining information about the document processing system or the locations of the document processing system for sending documents to be printed. For example, the label may include information about the document processing system and the mobile computing device queries a database to determine the network address of the document processing system.

In an example embodiment, a method includes determining if a mobile computing device is in proximity of the document processing device and selectively sending identifying data about the document processing device to the mobile computing device via a wireless personal area network interface based on the proximity of the devices. The method also can include transmitting a UUID using the wireless personal area network interface and receiving a response from a mobile computing device. The method can include determining the RSSI of the received response and approximating the distance to the mobile computing device based at least in part on the RSSI. The method can use the BLUETOOTH low energy protocol for the wireless personal area network. The method can further include receiving a document over a local area network from the mobile computing device and printing the document on the document processing device. The method also can include receiving, by the mobile computing device, data from multiple document processing system that are each in proximity to the mobile computing device. The mobile computing device can present a selection box that identifies the document processing systems and receive a selection of one of the document processing system to be used to print the document. The mobile computing device sends the document to be printed to the selected document processing system via a wireless connection to the local area network.

In an example embodiment, a document processing device includes a printer configured to print received documents, and a wireless personal area network interface configured to communicate with mobile computing devices using BLUETOOTH low energy communications. The wireless personal area network interface can determine an RSSI of received communications, and a processor can be configured to selectively send data based on the RSSI to the mobile computing device via BLUETOOTH to identify the document processing device to the mobile computing device. The document processing device can further include a local area network configured to receive documents to be printed. In response to sending the data identifying the document processing system to the mobile computing device over the wireless personal area network, the document processing system receives a document to be printed from the mobile computing device over the local area network. The processor also can be configured to broadcast a UUID via the wireless personal area network interface, receive a communication back in response from a mobile computing device, and establish a communication session with the mobile computing device via the wireless personal area network. The processor can be configured to terminate the communication session when the RSSI decreases below a threshold level, indicating the user has moved away from the document processing device.

### BACKGROUND

Document processing devices are in widespread use in many businesses and academic settings. Such devices include copiers, scanners, printers and facsimile machines. Today, one or more functions associated with such devices are combined in a single unit, referred to as a multifunction peripheral (“MFP”) or multifunction device (“MFD”). MFPs are typically connected to a network to allow users to print remotely from their computers, scan documents that can be sent to a user's computer or a third party's computer (for example via email), copy documents, or fax documents to other people.

When a user desires to print a document to an MFP, the user can discover available MFPs on the network, or information technology personnel can configure a user's computing device to use one or more MFPs by default. However, a user may not know the physical location of a particular MFP by the name or identifier used to identify the MFP on the user's computing device, particularly if the printer has been newly added, or if the user is in an unfamiliar location. Additionally, a user may want to print to a particular MFP based on the location of the MFP, for example based on the proximity of the MFP to the user, and may not know the name or identifier of a particular MFP. Also, for privacy reasons, a user may not want to print a sensitive document on an MFP until the user is physically present at the MFP so that the user can immediately retrieve the document after it has been printed.

### BRIEF DESCRIPTION OF THE DRAWINGS

FIG. 1 is a diagram of a proximity-based detection system included in a multifunction peripheral according to an embodiment of the disclosure.

FIG. 2 is a block diagram of components of a multifunction peripheral according to an embodiment of the disclosure.

FIGS. 3A and 3B are system overview diagrams of a multifunction peripheral that includes a proximity-based detection system according to an embodiment of the disclosure.

FIG. 4 is a system diagram of software components of a proximity-based detection system.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

The systems and methods disclosed herein describe a proximity-based detection system for a document processing device. Suitable document processing devices include scanners, copiers, printers, plotters and fax machines. Two or more of these functions can be contained in a single device or unit, referred to as a multifunction peripheral (MFP) or multifunction device (MFD), which may also serve as an e-mail or other information routing gateway. As used herein, MFP includes any device having one or more document processing functions such as those noted above. While example embodiments described herein refer to MFPs, it will be appreciated that they may be also applied to single use devices, such as a printer.

The disclosed proximity-based detection system enables a user to select an MFP for printing documents by being in proximity to the MFP. In a first embodiment, the user detects an MFP that is in proximity to the user, for example by scanning identifying markers on the MFP using the camera of a mobile computing device. In a second embodiment, the MFP detects when a user's mobile computing device is in proximity, for example by using the proximity detection capabilities of the BLUETOOTH low energy protocol, also known as BLUETOOTH LE. A third embodiment can use a combination of both detection methods.

Advantageously, a proximity-based detection system can assist a user with printing a document to a desired MFP. Also, the proximity-based detection system allows a user to wait until the user is in proximity to the MFP before printing a document, avoiding the possibility that a sensitive document may be printed and visible to other parties before the user arrives at the MFP to retrieve the printed document. Similarly, the proximity-based detection system allows users to avoid the situation where a print job could be queued to an MFP that is either busy or out of service, requiring the user cancel the print job and find another suitable MFP to which to print. Cancelling a print job can require the user to leave the vicinity of the MFP while the print job is still in the queue in order to cancel the print job on a remote computing system, thus creating the possibility that a sensitive document may be printed prior to the user cancelling the print job. The disclosed proximity-based detection system addresses these and other problems associated with printing to MFPs.

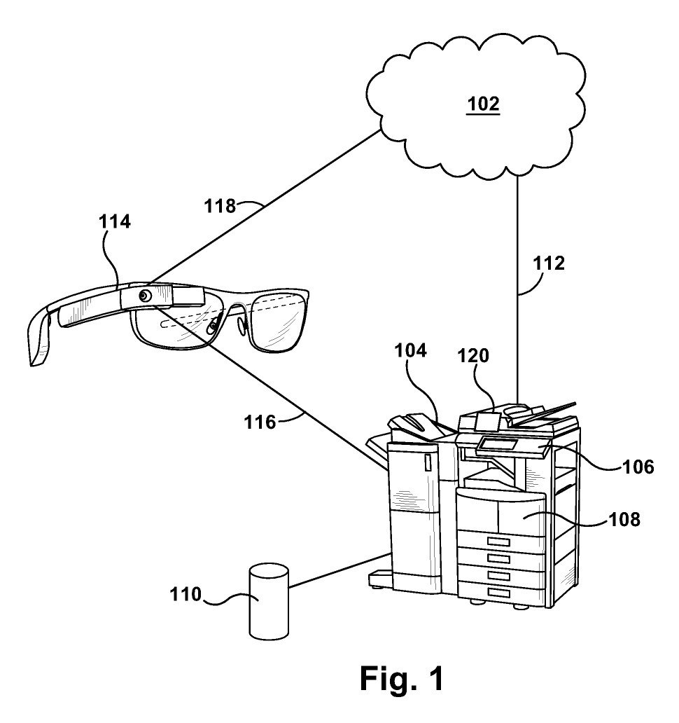

Turning to FIG. 1, a document processing system 100 with proximity-based detection is presented. The document processing system 100 includes a network 102 that is in data communication with one or more document processing devices, suitably comprised of an MFP 104 as illustrated. MFP 104 is suitably operable for printing, faxing, scanning, copying, e-mailing, or any other document processing operation will be understood by one of ordinary skill in the art. In the illustrated embodiment, MFP 104 includes a user interface 106 suitably comprising a display screen. Operation of the MFP 104 is suitably managed by an embedded controller 108 and embedded data storage 110.

In the example embodiment of FIG. 1, MFP 104 is coupled for data communication 112 with network 102, suitably comprised of a local area network (LAN), a remote local area network (RLAN), a wide area network (WAN) which may comprise the Internet, or any combination thereof.

The mobile computing device 114 is configured for data communication 118 with network 102. The mobile computing device 114 can communicate with the MFP 104 using the network 102. For example, the mobile computing device 114 can print a document to MFP 104 over the network 102.

In an embodiment, MFP 104 also is coupled for short range data communication 116 with a mobile computing device 114. The mobile computing device 114 can be a heads up display, for example GOOGLE GLASS. In other configurations the mobile computing device can be any suitable computing device worn or carried by a user including, but not limited to, a smart phone such as the APPLE IPHONE or a smart watch, such as an APPLE MATCH or an ANDROID-based smart watch. In a configuration, the short range data communication protocol is BLUETOOTH low energy, although other suitable data communication protocols can also be used.

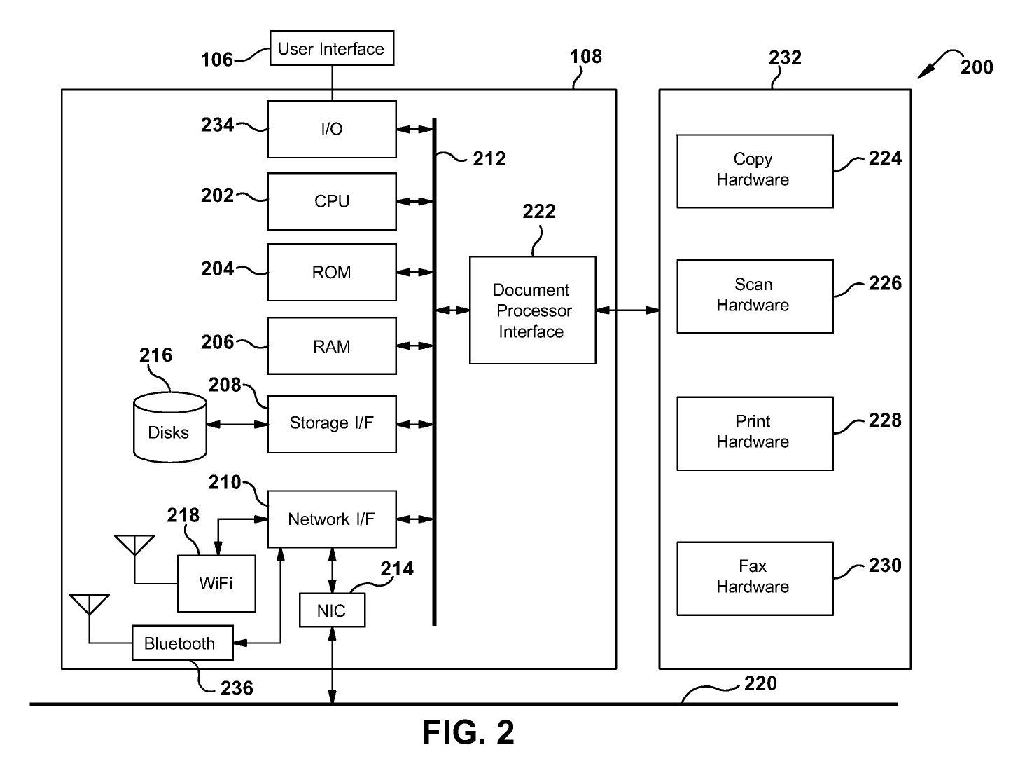

Turning now to FIG. 2, presented are functional components 200 suitably comprising a multifunctional peripheral such as MFP 104 of FIG. 1. Included is an example embodiment of controller 108 which is suitably comprised of a computer. Included in the example controller 108 are one or more processors, such as are illustrated by central processor unit (CPU) 202. Also included are non-volatile memories, such as read-only memory (ROM) 204, random access memory (RAM) 206, a storage interface 208, a network interface 210, and I/O interface 234. In the example embodiment, CPU 202, ROM 204, RAM 206, storage interface 208, network interface 210, and I/O interface 234 are in mutual data communication via bus 212. Storage interface 208 facilitates data access with bulk data storage, such as one or more disks 216, or any other suitable data storage such as a flash drive, solid state storage drive, CD, DVD or the like.

Network interface 210 suitably provides for external data communication, such as with a network interface connection (NIC) 214, WiFi interface 218, or BLUETOOTH interface 236. NIC 214 or WiFi interface 218 suitably provide for connection to an associated local area network 220. BLUETOOTH interface 236 suitably provides for communication with nearby mobile computing devices as described above for FIG. 1. BLUETOOTH is an example of a wireless personal area network interface that is typically used for point-to-point communications between two local devices. BLUETOOTH advantageously does not require connection to a local area network. A document processor interface 222 is also in data communication with bus 212, and provides a gateway to copy hardware 224, scan hardware 226, print hardware 228 and fax hardware 230 which together comprise MFP functional hardware 232.

The input/output controller or I/O interface 234 suitably provides support for the user interface 106 and can include support for a display screen, touchscreen inputs, key inputs such as keypad or keyboard inputs, audible outputs such as a speaker, and so forth. I/O interface 234 can support standardized inputs and outputs, such as VGA, HDMI, USB, and serial interfaces, or can be configured to support proprietary cabling and/or proprietary interfaces.

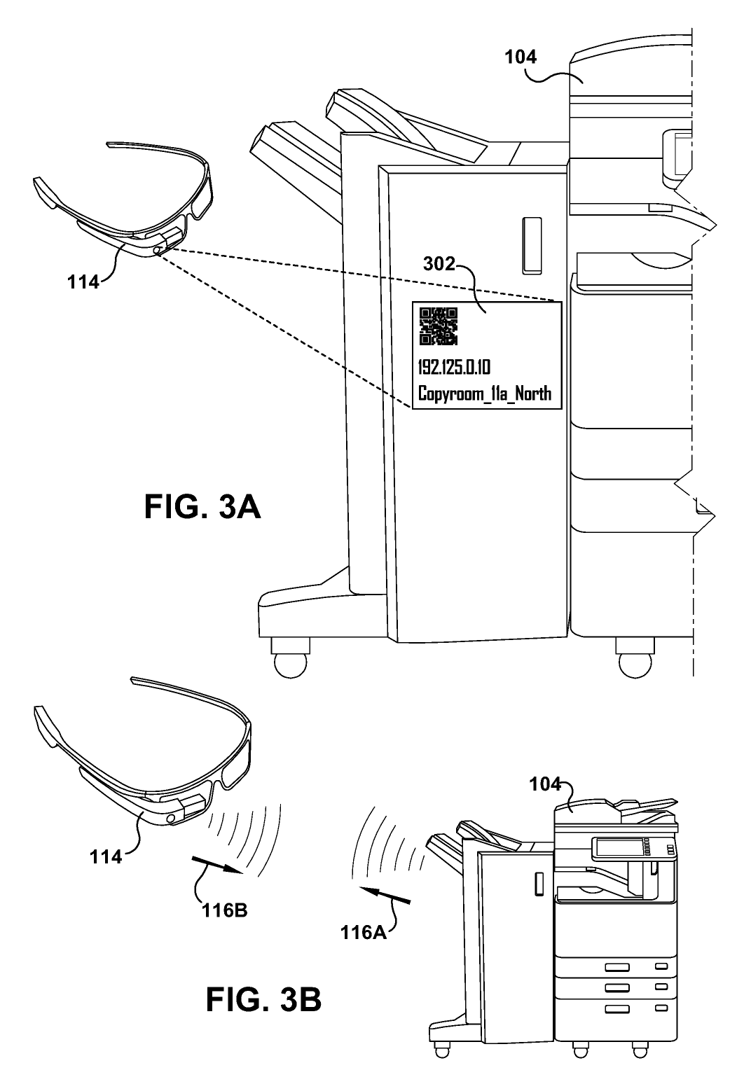

Turning now to FIG. 3A, a first system overview diagram is presented. In the first system overview diagram, a mobile computing device 114, such as the heads up display of FIG. 1, is in close proximity to the MFP 104. An application executing on the mobile computing device 114 enables the user to identify the MFP 104. The mobile computing device 114 images a label 302 or other identifying indicia that is located on or near the MFP 104. For example, the label 302 can be a QR code, or quick response code, a barcode, the name of the MFP 104, a serial number of the MFP 104, an IP address, a MAC address, a URL or uniform resource locator, or any other suitable unique identifier. The mobile computing device 114 can image the label 302 using a camera of the mobile computing device 114. In these configurations, the mobile computing device 114 can determine the identity of the MFP 104 directly from information provided on the label. Alternatively, the information obtained from the label 302 can be used to query a database to obtain the identity of the MFP 104. In another configuration, the mobile computing device 114 can use position information such as GPS, radio triangulation, or WIFI hotspot information and compare the position information with a database of locations of MFPs 104. Once the mobile computing device 114 has determined the identity of the MFP 104, the user can direct the MFP 104 to print the user's document, for example by sending the document to the MFP 104 via a wireless local area network.

Turning now to FIG. 3B, a second system overview diagram is presented. In the second system overview diagram, the mobile computing device 114 and the MFP 104 use the BLUETOOTH low energy protocol to pass information about the identity of the MFP 104 to the mobile computing device 114. The MFP 104 periodically transmits 116A a UUID, or universally unique identifier as a broadcast. When a mobile computing device 114 is in proximity to the MFP 104, the mobile computing device 114 transmits 116B a response to the broadcast. The BLUETOOTH low energy protocol supports proximity sensing, allowing the MFP 104 to approximate the distance to the mobile computing device 114. If the MFP 104 determines that the mobile computing device 114 is within a threshold proximity to the MFP 104, then the MFP 104 sends identifying information to the mobile computing device 114. The MFP 104 and mobile computing device 114 can establish and maintain a communication session while the user is present at the MFP 104. When the user begins to walk away from the MFP 104 and the RSSI signal strength decreases, the MFP 104 can terminate the communication session.

In another configuration, the mobile computing device 114 and MFP 104 can use NFC, or near field communications, or other wireless protocols to pass information about the MFP 104 to the mobile computing device 114 as would be understood in the art. Once the mobile computing device 114 has determined the identity of the MFP 104, the user can direct the MFP 104 to print the user's document, for example by send the document to the MFP 104 using a wireless local area network.

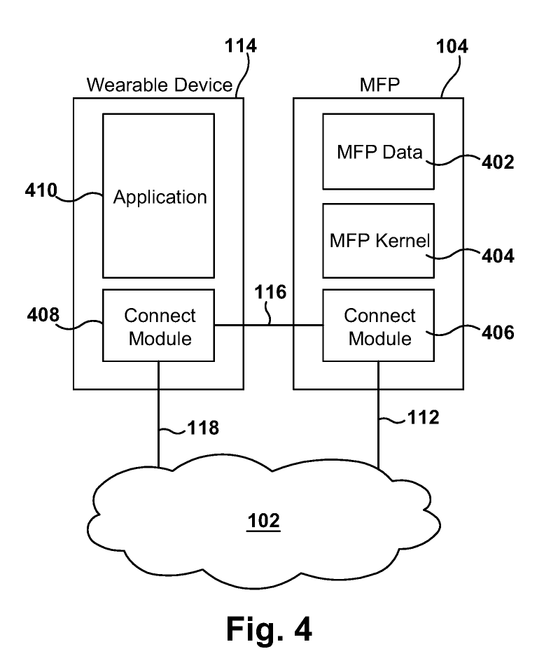

Referring now also to FIG. 4, presented are example software modules blocks for a mobile computing device 114 and an MFP 104 with a proximity-based detection system. In the MFP 104, the MFP data module 402 stores identifying data about the MFP 104, such as an IP address, a MAC address, a serial number, the name of the MFP 104, or any other suitable uniquely identifying information. The Communications Module 406 provides the stack for supporting BLUETOOTH low energy communications with mobile computing devices 114. The MFP Kernel module 404 causes the Communications Module 406 to periodically transmit a message, such as a broadcast of a universally unique identifier, or UUID, to communicate with any mobile computing devices 114 in proximity to the MFP 104. If a mobile computing device 114 receives the broadcast from the MFP 104 then the mobile computing device 114 transmits a response back to the MFP 104. The Communications Module 406 of the MFP 104 can determine the received signal strength indication, or RSSI, of the received response. The MFP Kernel module 404 can approximate the distance to the mobile computing device 114 based on the RSSI. If the mobile computing device 114 is determined to be within a threshold distance of the MFP 104, then the MFP Kernel module 404 can send the identifying data about the MFP 104, as well as other data, to the Communications Module 406. The Communications Module 406 packetizes the data into a BLUETOOTH packet and wirelessly transmits the BLUETOOTH packet to the mobile computing device 114.

In the mobile computing device 114, a similar Communications Module 408 provides the stack for supporting BLUETOOTH low energy communications 116 with the MFP 104 and other BLUETOOTH devices. The Communications Module 408 can determine the approximate distance to the MFP 104 based on the RSSI, or received signal strength indication. If more than one MFP 104 is present, the RSSI can provide an indication as to which MFP 104 is closest to the mobile computing device 114 and the user. The Communications Module 408 depacketizes the BLUETOOTH low energy communications 116 received from the MFP 104 and passes the received data to the Application Module 410. The data sent between the MFP 104 and the mobile computing device 114 can be suitably packetized, for example using any of the TCP/IP family of protocols.

An Application, or Application Module 410, executes on the mobile computing device 114. The Application Module 410 receives the data from the Communications Module 408, for example in TCP/IP packets. The data can include identifying information about an MFP 104 that is in proximity to the mobile computing device 114. For example, the identifying information can be the MAC address, IP address, serial number, or name of the MFP 104 or any other suitable identifying indicia for uniquely identifying the MFP 104. If more than one MFP 104 is in proximity to the mobile computing device 114, the Application Module 410 can receive identifying information from each MFP 104. If more than one MFP 104 provides identifying information, the Application Module 410 can present a selection box to the user that allows the user to select which MFP 104 to use.

Once the MFP 104 is identified and selected by the user on the mobile computing device 114, the user can select a document to print on the MFP 104. The document is sent via network communications 118, 112 through the network 102 to the MFP 104, which schedules the document as a print job to be processed. In a configuration, instead of sending the document itself to the MFP 104, the mobile computing device 114 sends document information to the MFP 104 which includes identification of the document on a remote server that is to be printed by the MFP 104. In an embodiment, the Application Module 410 is configured to identify and select a MFP 104 to be used as the printer, but a different application on the mobile computing device 114 can send the document to the MFP 104 to be printed. In an embodiment, the Application Module 410 facilitates both selecting the document to be printed and also identifying and selecting the MFP 104 to be used for the print job. For example, in this embodiment a user can first select a document to be printed, and then use the mobile computing device 114 to select the MFP 104 to perform the printing as described above. This allows the user to seamlessly select a document, look at a particular MFP 104 to select the MFP 104, and have the document automatically printed by the selected MFP 104, all from the user's mobile computing device 114.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

1-20. (canceled)

21. A portable data device comprising:
a digital camera;
a memory configured to store image data captured from the camera;
a wireless data interface;
a processor configured to identify one of a plurality of document processing devices in accordance with stored image data;
the processor configured to communicate an instruction to the document processing device via the wireless data interface to commence a document processing operation on the identified document processing device.

22. The device of claim 21 further comprising the digital camera configured to capture the image data corresponding to visual indicia on an exterior of the identified document processing device.

23. The device of claim 22 further comprising the digital camera configured to capture the image data corresponding to a barcode.

24. The device of claim 23 further comprising the digital camera configured to capture the image data comprised of a three-dimensional barcode.

25. The device of claim 22 further comprising the processor configured to identify the one of the plurality of document processing devices in accordance with a comparison of the stored image data with stored identification data for each of the plurality of document processing devices.

26. The device of claim 25 further comprising:
the processor configured to communicate the image data to an associated server via the wireless data interface;
the processor configured to receive a device identification data corresponding to communicated image data via the wireless data interface; and
the processor configured to identify the one of the plurality of document processing devices in accordance with received device identification data.

27. The device of claim 22 wherein the portable data device is comprised of an optical, head mounted display device.

28. A portable data device comprising:
a display;
a sensor configured approximate a distance between the portable data device and at least one associated multifunction peripheral;
a wireless data interface configured to receive, into a memory, image data from the at least one multifunction peripheral communicated in accordance with a comparison of an approximated distance to a preset proximity threshold;
a processor configured to generate an image on the display corresponding to received image data and identifying the at least one multifunction peripheral;
an input configured to receive, from a user, a multifunction peripheral selection made in accordance with a generated image; and
the wireless interface configured to output a document processing instruction to a selected multifunction peripheral.

29. The system of claim 8 wherein the sensor is comprised of a signal strength indicator corresponding to a signal strength of wireless communication between the wireless data interface and the at least one multifunction peripheral.

30. The system of claim 29 wherein the wireless data interface is comprised of a BLUETOOTH interface.

31. The system of claim 29 wherein the wireless data interface is comprised of a near field communications interface.

32. The system of claim 29 wherein the processor is configured to specify an electronic document to be sent to the selected multifunction peripheral.

33. The system of claim 29 wherein the processor is configured to send, from the memory, the electronic document to the selected multifunction peripheral.

34. The system of claim 29 wherein the processor is configured to direct communication of the electronic document to the selected multifunction peripheral from a remote server.

35. A multifunction peripheral comprising:
an embedded controller including a processor, a memory in data communication with the processor, and a data interface including a wireless data interface in communication with the processor, the memory operable for storage of data and instructions, and the wireless data interface configured for data communication with a mobile computing device;
a sensor configured to approximate a distance between the multifunction peripheral and the mobile computing device in accordance with a wireless data communication signal strength;
the processor configured to compare data corresponding to an approximated distance with data corresponding to a preselected distance threshold;
the processor configured to selectively output, from the memory, image data identifying the multifunction peripheral to the mobile computing device via the data interface in accordance with a comparison of the approximated distance with the preselected distance threshold;
the data interface configured to receive a device selection instruction from the mobile computing device; and
the processor configured to commence a document processing operation responsive to a received device selection instruction.

36. The multifunction peripheral of claim 35 further comprising :
the data interface configured to receive electronic document into the memory; and
the processor configured to commence the document processing operation on the received electronic document.

37. The multifunction peripheral of claim 36 wherein the electronic document is received from the mobile computing device via the wireless data interface.

38. The multifunction peripheral of claim 36 further comprising the data interface configured to receive a document identifier corresponding to the electronic document from the mobile computing device.

39. The multifunction peripheral of claim 38 wherein the electronic document is retrieved via the data interface from a remote server in accordance with a received identifier.

40. The multifunction peripheral of claim 38 wherein the electronic document is retrieved from a local storage in accordance with a received identifier.
